(19) United States
(12) Patent Application Publication
(10) Pub. No.: US 2016/0106133 A1
(43) Pub. Date: Apr. 21, 2016

(54) METHOD AND APPARATUS FOR AGING MEAT

(71) Applicant: Claus Schmitz, San Diego, CA (US)

(72) Inventor: Claus Schmitz, San Diego, CA (US)

(21) Appl. No.: 14/874,461

(22) Filed: Oct. 4, 2015

Related U.S. Application Data
(60) Provisional application No. 62/065,613, filed on Oct. 18, 2014.

(51) Int. Cl. A23L 1/318; G05D 22/02; G05D 23/19; A23B 4/16

(52) U.S. Cl. CPC A23L 1/3187; A23B 4/16; G05D 22/02; G05D 23/1917

(57) ABSTRACT

A method and apparatus are provided for aging meat implemented in a form available to the general consumer market. A cooling device comprising a refrigerated chamber is instrumented to provide a controlled atmosphere. This means provides for the aging of meat. Sensors are provided to monitor controlled atmosphere parameters. These parameters may be commanded by a remote control unit via a local control unit or via a communications link. Commands to a control circuit can be provided from a smart phone loaded with an aging app. Through the app, the user may vary operational parameters. The user may vary the aging process, accelerate it, or stop it. The user can monitor the aging process, react to alarm conditions, derive new relationships between data and results, and develop new aging routines.

### CROSS-REFERENCE TO RELATED APPLICATIONS

This patent application claims priority from Provisional Patent Application Ser. No. 62/065,613 entitled Steak Locker—Portable Electric Cooler filed on Oct. 18, 2014. The contents of this provisional patent application are fully incorporated herein by reference.

### FIELD

The present subject matter relates to aging of meat and more particularly to a method and apparatus in which the process of aging is controlled.

### BACKGROUND

Aging of meat is a process in which moisture is reduced and in which natural enzymes are allowed to tenderize the meat. Prior art methods do not provide for control of the process other than providing a linear set of steps that are timed and followed. Meat aging apparatus has not been built in a manner to be readily accessible to consumers. Typical meat tenderizing apparatus is large enough to handle commercial qualities of meat.

U.S. Pat. No. 7,998,517 discloses a process for dry aging meat in an enclosed, atmosphere-controlled room with forced circulation, containing a stainless steel salt rack with a salt br404ick stack covering one wall. A plurality of unwrapped and uncovered meat is placed on a meat rack. During the aging process, the meat pieces are moved toward the salt rack in steps. Each step lasts a preselected number of days. The process continues to the end of the aging period. Due to complication of construction and operation, this aging process is unsuitable for general consumer use.

United States Patent Application Publication Number 2014/0037829 discloses a method of dry aging meat including covering an exposed portion of the meat with at least one layer of fat and/or bone that is separate from the meat. The layer of fat and/or bone is kept on the meat for duration of aging. The need to cover the meat increases expense and decreases reliability.

U.S. Pat. No. 4,772,480 discloses controlling the aging or maturing of edible material such as meats, fish, dairy products, cereals, etc. by keeping the edible material in the presence of a freezing point depressing agent and an extract from the edible material at a temperature ranging from 0° C. to the freezing point of the material in order to accomplish aging. This aging process is unsuitable for general consumer use.

### SUMMARY

Briefly stated, in accordance with the present subject matter, a method and apparatus are provided for aging meat which can be implemented in a form available to the general consumer market and which may be portable.

A cooling device comprising a refrigerated chamber is instrumented to provide a controlled atmosphere. This means provides for the aging of meat. Sensors are provided to monitor controlled atmosphere parameters. These parameters may be commanded by a remote control unit via a local control circuit or via a communications link. Commands to the control circuit can be provided from a smart phone loaded with an aging app. Through the app, the user may vary operational parameters. The user may vary the aging process, accelerate it, or stop it. The user can monitor the aging process, react to alarm conditions, derive new relationships between data and results, and develop new aging routines.

The cooling system may be of a size useful in residential applications. The cost compared to commercial units is low. Consumers that purchase large quantities of meat can cheaply benefit from aging meats to reduce excess moisture through evaporation and provide breakdown of enzymes, thereby tenderizing the meat. The method and apparatus may be used by consumers having ordinary culinary skills.

The method and apparatus may be used for curing in applications in which a user wishes to control time, temperature, humidity, and air flow.

### BRIEF DESCRIPTION OF THE DRAWINGS

FIG. 1 is a block diagram of the present system;

FIG. 2 is an elevation of an aging apparatus;

FIG. 3 is an isometric view of the aging apparatus;

FIG. 4 is a block diagram of a control circuit for operating the aging apparatus;

FIG. 5A is an isometric view of a humidifier included in the aging apparatus;

FIG. 5B is an exploded view of the illustration of FIG. 5A;

FIG. 6 is a flowchart of a software routine for operating the control circuit;

FIGS. 7A, 7B, 7C, 7D, and 7E each illustrate a screen of a graphical user interface (GUI); and

FIG. 8 is a flowchart illustrating operation of the app included in a portable interactive device such as a smart phone.

### DETAILED DESCRIPTION

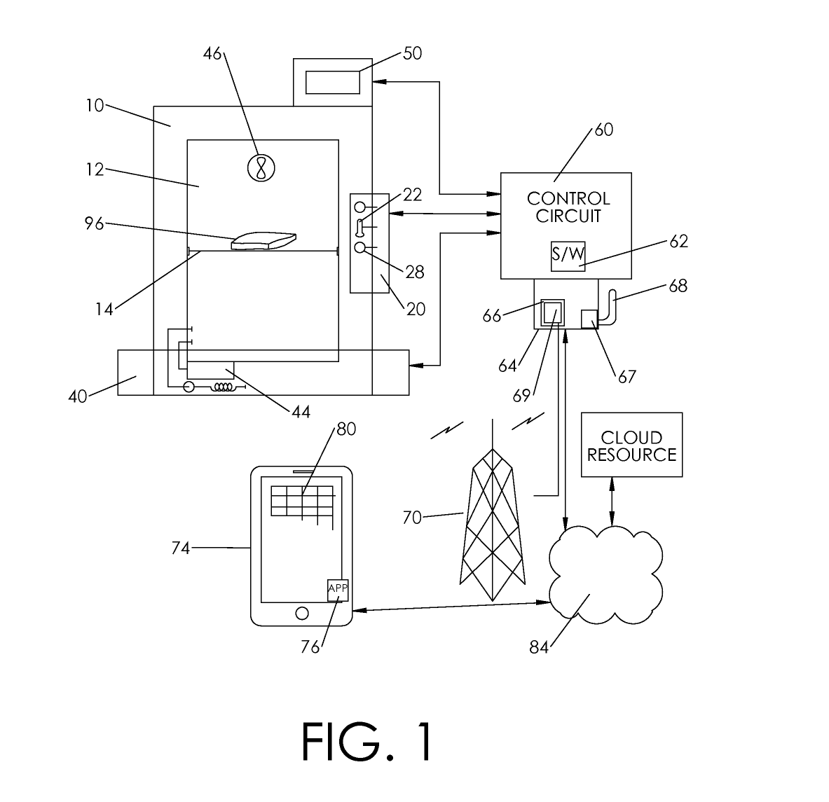

FIG. 1 is a block diagram of the aging system 1 according to the present subject matter. The aging system 1 controls aging parameters. In the present description, “aging parameters” refers to selectable characteristics that are controllable to produce a desired result from the aging process. Basic aging parameters include humidity, temperature, and airflow. Meat is aged in an aging apparatus 10 housing a refrigerated chamber 12. A support rack 14 is mounted in the refrigerated chamber 12 to support meat. Other means of support could be provided.

An aging process may be viewed as a protocol which occurs over a preselected time span. Over the preselected span, aging parameters are controlled. The protocol defines a desired value for each aging parameter over the time span of the aging process. One widely used protocol is performed over a ten-day time span. Temperature, relative humidity, air movement, and general sanitation of the aging room are maintained. Aging parameters are kept constant over the time span. Temperature of an aging chamber is maintained at approximately 34 to 36 degrees Fahrenheit, relative humidity at 85 to 90 percent, and air flow at 15 to 20 linear feet per minute at the surface of the product.

Staying within the protocol is important for achieving the desired result, namely a meat that will please a consumer. There is no universal ideal. One aging protocol will yield a steak, for example, that one person finds perfect and another person finds unsatisfactory. Restaurants and meat purveyors select widely acceptable protocols. In accordance with the present subject matter, a consumer may select a protocol customized to the consumers taste. The consumer may even change the protocol in midstream.

An instrumentation module 20 monitors conditions within the refrigerated chamber 12. Many different sets of condition-sensitive sensors may be provided. In one preferred form, the sensors include a thermometer 22, a hygrometer 30, a timer 26, and a fan sensor 28. Conditions within the refrigerated chamber 12 are produced by environment apparatus 40. The environment apparatus 40 may commonly comprise a refrigeration unit 38, a thermostat 42, a humidifier 44, a humidistat 24, and a fan 46. The environment apparatus 40 will produce desired levels of temperature, humidity, and airflow. Reports may be provided from and commands may be provided to local graphical user interface 50.

A control circuit 60 is set by a user in order to produce conditions to achieve a desired aging result. Control software 62, which defines an aging program, is provided as further described below. The control circuit 60 is coupled to communicate current and recorded data to a communications interface 64. The communications interface 64 may include various forms of apparatus. The communications interface 64 need not be a discrete unit. The communications interface 64 may be integrated into other circuits.

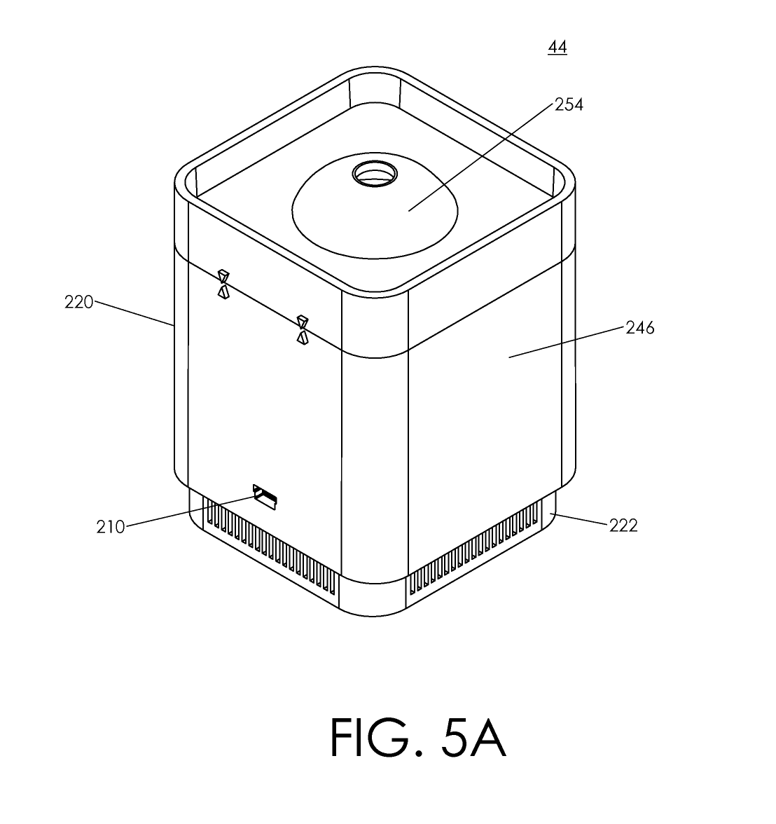

A Wi-Fi interface 67 transmits signals from the control circuit 60 to an antenna 68. Communication may be accomplished by networks, telephone systems, or other systems. In the present illustration, the communications interface 64 is coupled to a communications link 66. The communications link 66 will conveniently comprise a telephone modem 69 coupled to a cellular phone system 70. The control circuit 60 is further described below with respect to FIG. 4. The cellular phone system 70 communicates with a portable interactive device, exemplified by a smart phone 74. An “app” 76 is installed in the smart phone 74 to receive and evaluate reports from the instrumentation module 20 and to communicate commands to the environmental apparatus 40. An app GUI 80 is provided for interactions between the smart phone 74 and the control circuit 60. An app is embodied in a non-transitory programmed medium which when executed on a digital processer causes the processor to perform the steps of the app.

Communications may also be made via the Internet 84. Communications may be direct. Also, data may be sent to and accessed from a Cloud resource 88 via the Internet 84.

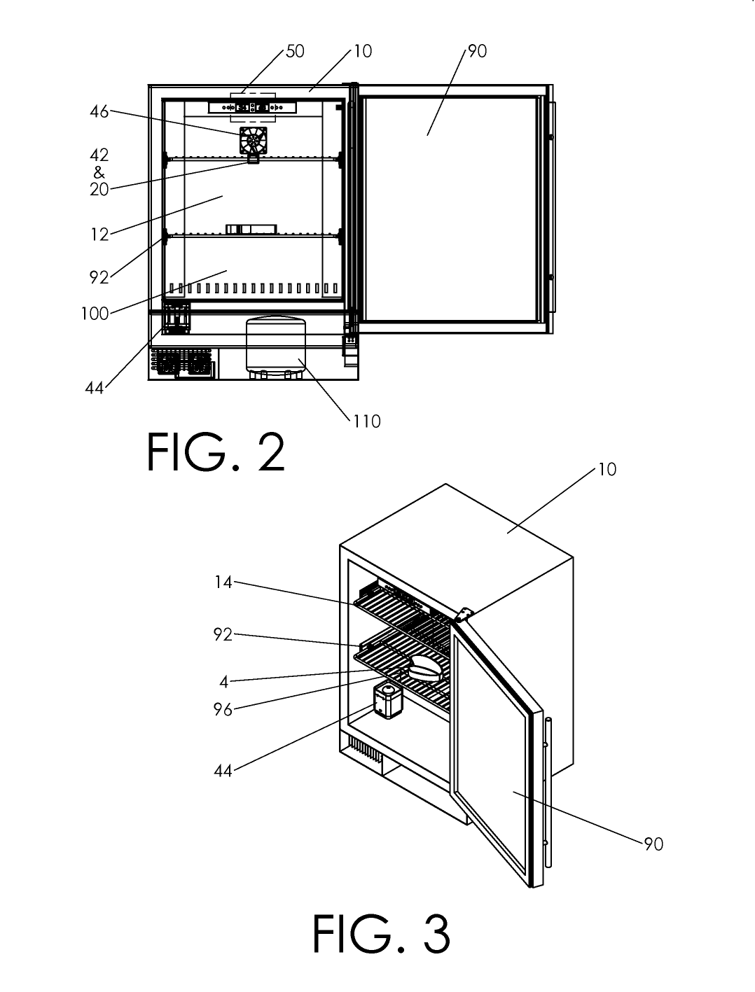

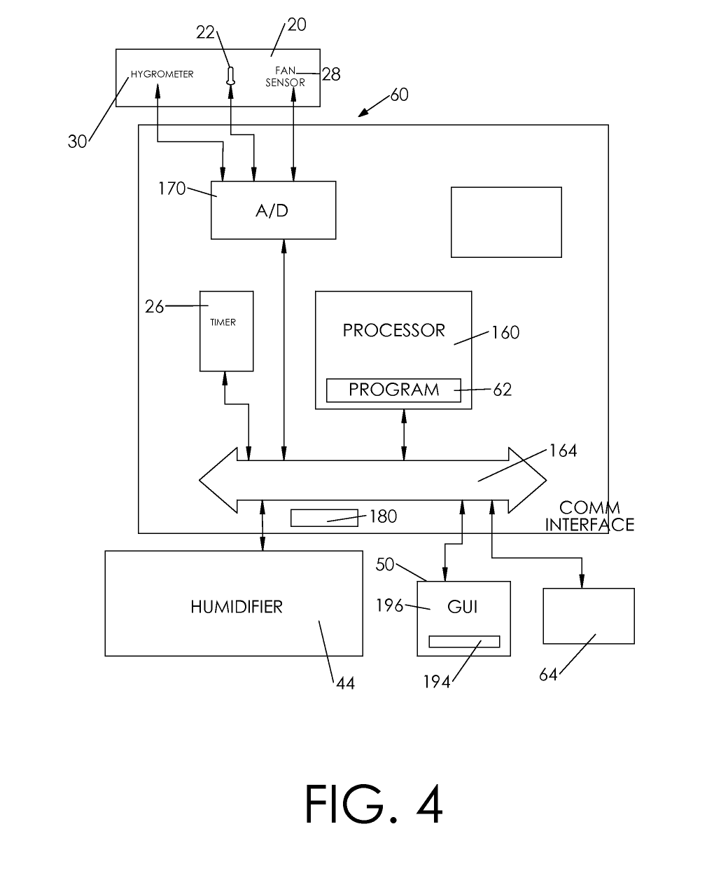

FIG. 2 is an elevation of an aging apparatus 10. FIG. 3 is an isometric view partially broken away of the aging apparatus 10. The refrigerated chamber 12 comprises an enclosure which is closed by a door 90. The support rack 14 is supported by slide means 92 or other support to maintain a cut of meat 96 in a position to be in a desired airflow. The instrumentation module 20 may be mounted to the rear wall 100. The timer 26 (FIG. 1) may be placed in the refrigerated chamber 12, may be placed in exterior position, or may be embodied in the control circuit 60 (FIG. 1). The fan 46 is preferably mounted in a rear wall 100 of the refrigerated chamber 12. The humidifier 44 is preferably placed in a lower portion of the refrigerated chamber 12. The thermostat 42 may be located in the rear wall 100. The thermostat is connected to selectively operate a refrigeration compressor 110 supported in a lower portion of the aging apparatus 10.

FIG. 4 is a block diagram of the control circuit 60. The control circuit 60 comprises a processor 160. The control software 62 is loaded in the processor 160. The control software 62 produces interaction of inputs and outputs as further described below. Communication between components discussed below is made via a data bus 164. Inputs are provided to the control circuit 60 from the instrumentation module 20. These inputs include signals indicative of measurements from the thermometer 22, hygrometer 30, and the fan sensor 28. An analog to digital (A/D) converter 170 may be provided intermediate the sensor module 20 and the data bus 164. Most sensors on the market provide analog outputs. A sensor providing a digital output may be coupled directly to the data bus 164.

The timer 26 may be included in the control circuit 60 and receives inputs from the processor 160 to determine duration of commanded operations. The timer 26 need not comprise a discrete component. The timer 26 may comprise a clock circuit within the processor 160. A digital to analog (D/A) converter 180 may couple commands from the processor 160 to the humidifier 44, fan 46, and compressor 110. The data bus 164 also provides outputs to the local graphical user interface (GUI) 50. The local GUI 50 may take many different forms. The local GUI 50 may comprise a display 194 in a housing 196. The housing 196 may be mounted to the aging apparatus 10 (FIG. 2). A plurality of local GUIs 50 may be provided so that a user may interact with the aging apparatus 10 at the aging apparatus 10 itself or at a selected remote physical location. Interaction may also be provided via the app GUI 80 at the smart phone 74 (FIG. 1).

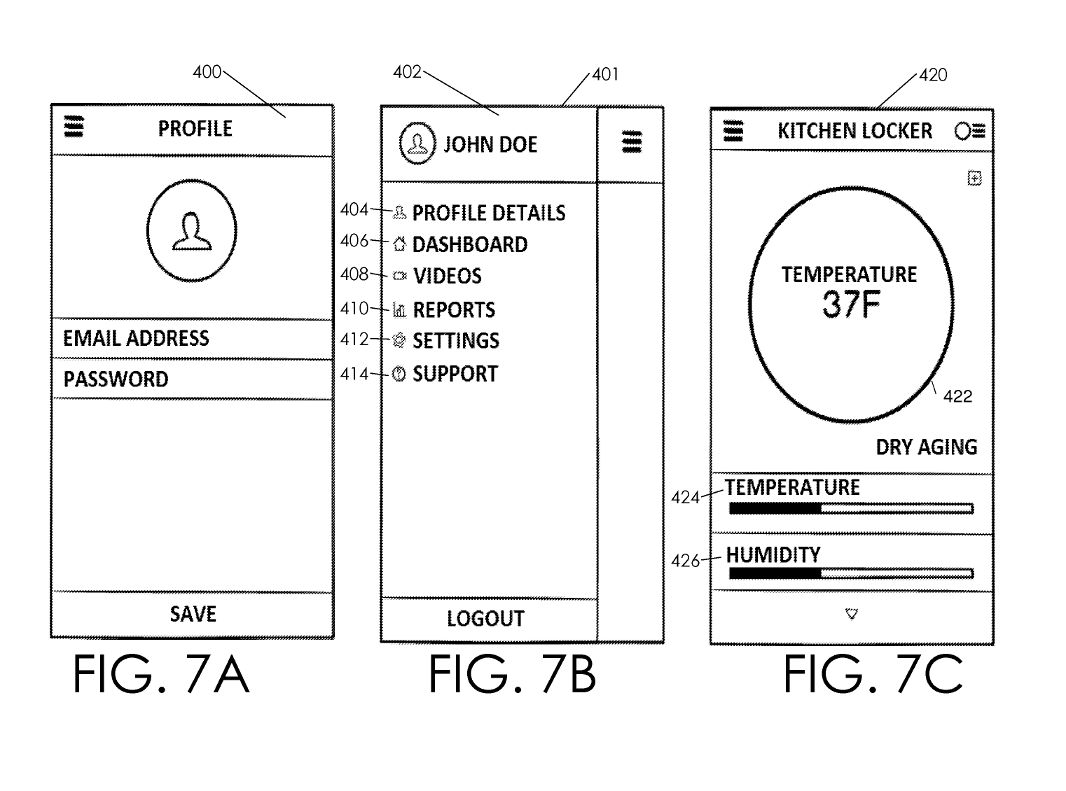

The data bus 164 also communicates with the communications interface 64. Any number of techniques may be used to couple the communications interface 64 to the telephone link 66. For example, the communication interface 64 may be connected to a USB port 210 (FIG. 6). The USB port 210 may be placed on a printed circuit board or a physical housing for the printed circuit board. The communications interface 64 may be located in the control circuit 60 within the aging apparatus 10. The telephone link could alternatively be located outside of the aging apparatus 10.

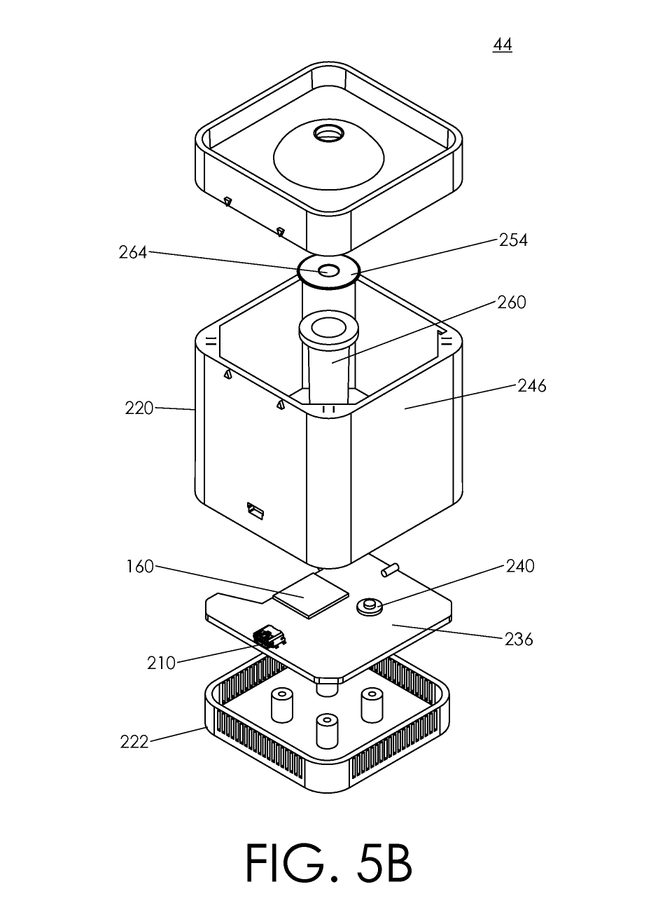

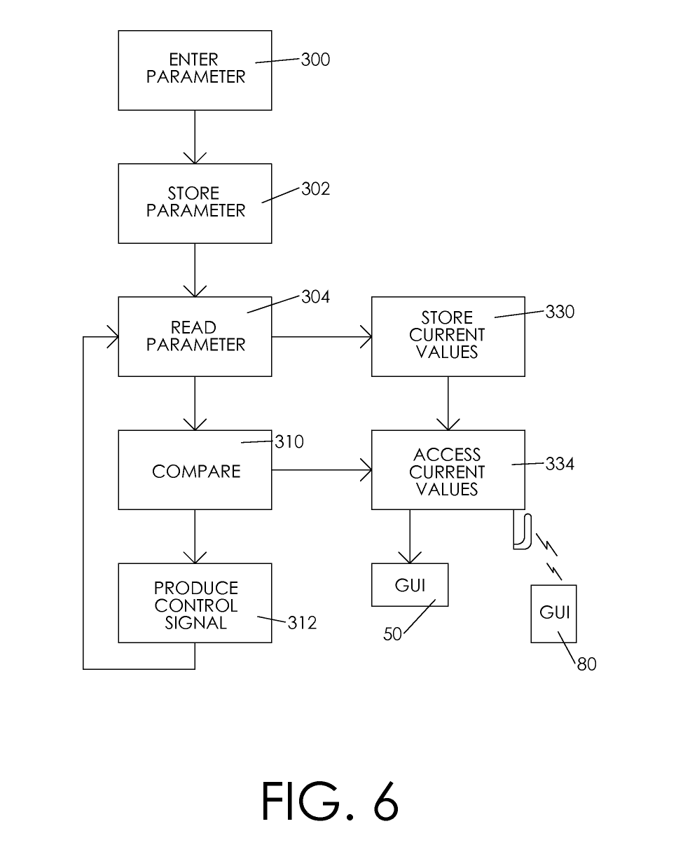

FIG. 5A is an isometric view of the humidifier 44 included in the aging apparatus 10, and FIG. 5B is an exploded view of the illustration of FIG. 5A. Humidifier 44 comprises a housing 220 with a lower section 222 and upper section 224. A humidity control circuit 236 housed in the lower section 222 responds to a hygrometer 240. The humidity control circuit 236 and hygrometer 240 comprise the humidistat 24 (FIG. 1). A platform 244 separates the upper and lower sections 222 and 224. The humidistat 24 communicates with the control circuit 60 as described above. The upper section 224 includes a reservoir 246 which supplies water to an atomizer 254, preferably a piezoelectric disk.

The humidifier 44 comprises a central reservoir 246 in which a tube 260 with a cotton core is placed. Water is drawn up the cotton core via capillary action. At a top of the tube 260 in a cap portion 264 the atomizer 254 converts water to water vapor. The lower section 224 of the humidifier houses all of the electrical components that monitor and process both temperature and humidity. The humidistat 24 maintains a predetermined level of humidity. Signals are sent from the control circuit 60 to the app 76 (FIG. 1). The signal may then be sent to the cloud resource 88, e.g., a cloud server, where it is monitored via the app 76 on the smart phone 74.

FIG. 6 is a flowchart of a software routine for operating the control circuit. Selected ones of the operations below may be performed in parallel or in a different order unless logically impossible. For example, it is not possible to store values before they are entered. Operation begins at block 300. A user enters desired aging parameters. Entry may be made at a physical location or via the app 76 (FIG. 1) on the smart phone 74. At block 302, parameters are stored in the control circuit 60. At block 304, sensors in the instrumentation module 20 (FIG. 1) are read. Values from the sensors 20 are compared at block 310 to programmed values which have been entered by the user at block 300. At block 312, control signals are produced for each operating component of the environment apparatus 40. Each control signal is based on a difference between a programmed setting and actual values read from the instrumentation module 20. Periodically, operation returns to block 304 in order to provide closed-loop control. Additionally, the control circuit 60 is periodically queried, generally by an internal clock, to provide current values to a parameter register at a block 330. Current parameter values may be accessed for display on the local GUI 50 or the app GUI 80 at block 334.

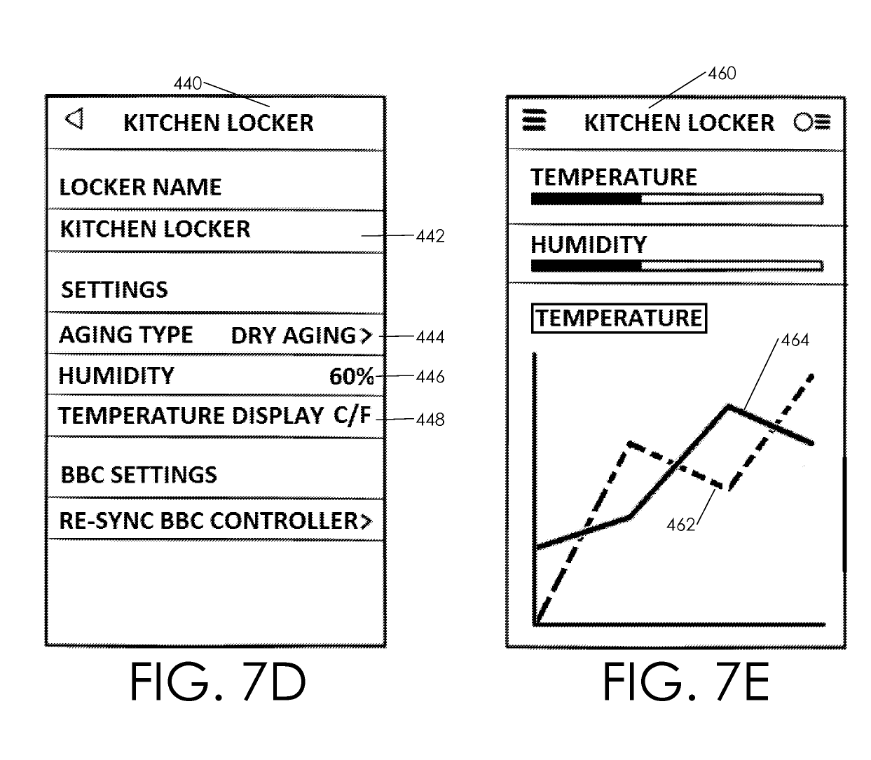

FIGS. 7A, 7B, 7C, 7D, and 7E each illustrate a screen of the app GUI 80 of the smart phone 74. FIG. 7A illustrates an opening screen 400 onto which a user may enter a password in order to access the app 76 (FIG. 1) by entering the screen 401 in FIG. 7B. A first field 402 may contain the name of the user. Profile field 404 allows a user to enter particular personal details. A dashboard field 406 permits coordination of displays and applications available to a user. Video field 408 allows a user to select videos. The videos could include records of surveillance of the aging apparatus 1. Report field 410 enables a user to request current or recorded raw or processed data. Settings field 412 is accessed in order to control various criteria such as desired aging temperature, duration, or selected alarm levels. Support field 414 may provide access to a customer support facility of a manufacturer or distributor of the aging apparatus 1.

FIG. 7C illustrates a report screen 420 which may be accessed by selecting field 410 (FIG. 7B). A first parameter field 422 is used to illustrate a value of a parameter, for example temperature. The first parameter field 422 may have a circular or other form. The first parameter field 422 may display digits and be color-coded to transmit additional information to a user. Second and third parameter fields 424 and 426 may be provided to display other parameters in graphical form. Any number of parameter fields may be provided and many different ways of conveying information may be used, e.g. charts, gauges, or numerical listings.

FIG. 7D illustrates a settings screen 440 accessed from the field 412 (FIG. 7B). A field may be provided for each parameter that a user may wish to vary. In the current illustration, an identification field 442 specifies the name of the apparatus being accessed. The app 76 may be used to control more than one aging apparatus 1. An aging field 444 may be provided for a user to select a type of aging, for example dry aging. A first parameter settings field 446 may be used for setting a parameter such as humidity. Separate parameter settings fields may be provided, or one parameter settings field 446 may be provided and used to select each of a plurality of parameters separately. A display field 448 is provided for selecting characteristics of display screens. These may include selection of Fahrenheit or Celsius temperature, correlation of a specific condition with a color in the first parameter field 422 in FIG. 7C, or other desired displays.

FIG. 7E illustrates a data field 460. The data field 460 may have a graphical display field 462. In the illustration of FIG. 7E, a graph 464 shows the value of a parameter, e.g., temperature, versus time. The graphical display field 462 may be provided with data that has been processed. For example, a rolling average of a parameter could be provided. Deviations of selected parameters from selected criteria may be recorded. Other useful information may be provided, such as energy consumption, change in weight of meat, or composite values collected over many aging cycles.

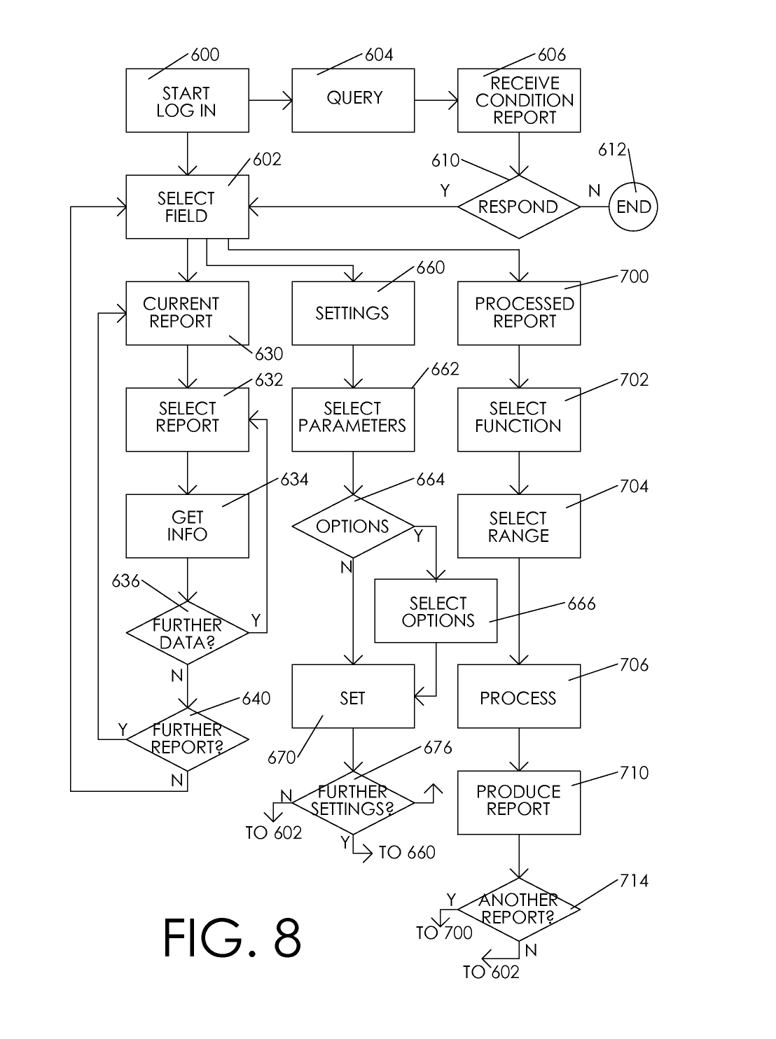

FIG. 8 is a flowchart illustrating operation of the app included in a portable interactive device such as a smart phone. Operation begins at block 600 when a user accesses the app 76 (FIG. 1) on the smart phone 74. At block 602, operation proceeds to the opening screen 400 (FIG. 7A). The user may select one of the fields 404-414. At the same time, the app 76, at block 604, automatically sends a query to the control circuit 60 so that any messages that have been determined to be important enough to warrant a user's immediate attention are produced. At block 606, any such urgent reports may be displayed on the opening screen 400. At block 610, a user has an option to respond to any urgent message. This may be done, for example, by accessing the other available fields. Alternatively, a field may be provided in the urgent message screen to immediately perform a custom or preselected response. At block 612, the initial automatic report sequence ends.

From block 602, a user may proceed to a selected routine for interacting with the aging apparatus 1. At block 630, a user may enter a current reports routine. At block 632 a parameter is selected, and a display, comprising a current parameter report, is provided at block 634. At block 636, a user is given an option to request another data point. If so, operation proceeds back to block 632, where another value is requested. If not, operation proceeds to block 640, wherein the user interface asks whether to repeat the current reports routine. If not, operation returns to block 602 at which a user may select a key. If so, operation returns to block 630.

At block 660 a user may enter a settings routine. At block 662 a user selects a setting to be made. At block 664, an option is provided in order to permit optional forms of setting the parameter. If the option is selected, operation proceeds to block 666 where further options are provided. If not, operation proceeds to block 670 where actual setting options are made. At block 676, the user is given the option to make further settings. If the user does select further settings, operation returns to block 660 and if not operation returns to block 602.

A user may enter a processed reports routine at block 700. Processed reports may comprise information regarding multiple aging procedures over time. Comparisons of the parameters versus results may be performed in order to populate a database or to calculate information for a particular aging occurrence. At block 702 a function is selected. At block 704 a data range or other range is selected from which data will be provided in order to calculate the desired information. At block 706 data is processed. At block 710, a report is produced. At block 714 a user makes a choice as to whether to return to the front page or back to block 700 for another report.

Meat is aged in a refrigerated chamber by execution of a preselected routine in which selected values of temperature and humidity are provided for preselected periods of time. Condition-responsive sensors provide both current and historical information. A user is enabled to communicate with control and monitoring apparatus during the aging routine. Communication is enabled via a communications link between the aging apparatus and a portable interactive device such as a smart phone. Through an app, the user may vary operational parameters. The user may vary the aging process, accelerate it, or stop it. Communication with the control unit may also be made via a local or networked remote control unit. A user may select various combinations of parameters for aging, such as temperature, humidity, and duration. The user may also process past data to derive information on which to base new aging routines. The method and apparatus may be used for curing applications in which a user wishes to control time, temperature, humidity, and air flow.

What is claimed is:

1. A method for aging meat comprising:
selecting an aging protocol defined by values of aging parameters over time;
selecting a set of values of aging parameters to define a current aging environment in a curing chamber, the aging parameters comprising selectable characteristics controllable to produce a preselected aging process;
operating environmental apparatus to establish the current aging operating environment;
monitoring current values of aging parameters;
remotely accessing current values of parameters;
comparing values of aging parameters at a preselected time to desired values within the protocol;
calculating a current proportion of the aging process compared to the complete aging process defined by the aging protocol; and
varying the aging parameters to provide a current integrated value in accordance with the aging protocol.

2. A method according to claim 1 wherein remote access comprises access via a wireless network.

3. A method according to claim 2 wherein remote access further comprises communicating by smartphone to the wireless network.

4. A method according to claim 1 wherein the selected aging protocol is replaced during the aging process.

5. A method according to claim 4 wherein said aging parameters comprise humidity, temperature, and airflow.

6. A method according to claim 5 wherein operating environmental apparatus comprises controlling a fan, a humidifier, and a refrigeration compressor.

7. A method according to claim 6 wherein remote access further comprises providing a graphical user interface on a portable interactive device and providing graphical representations of values of aging parameters.

8. A method for aging meat comprising:
providing a processor and storing in the processor a protocol for aging meat, the protocol being defined as a set of aging parameter values each parameter having a preselected value for a given time, the protocol further being defined by a time period;
monitoring current values of aging parameters and storing the current values in a memory;
querying the memory from a remote location;
displaying data indicative of the current values at the remote location; and
selectively providing an input command from the remote location for controlling environmental apparatus to produce current values of aging parameters.

9. A method according to claim 8 wherein querying the memory from the remote location comprises contacting the memory via a network with a portable interactive device.

10. A method according to claim 9 wherein said portable interactive device comprises a smartphone.

11. A method according to claim 9 wherein monitoring current values comprises reading outputs from a thermometer, hygrometer, and air flow sensor.

12. A method according to claim 9 wherein communicating between the memory and the portable interactive device comprises interfacing the memory to a communications link coupled to a communications network.

13. A meat aging apparatus comprising:
a residential refrigerator-sized aging chamber;
environmental apparatus comprising a fan, a humidifier, and a refrigeration compressor;
a processor embodying a program operating the environmental apparatus to perform an aging process in accordance with a stored protocol;
sensors connected for monitoring environmental parameters;
an uplink controller;
a network interface;
an operation control circuit comprising a wireless terminal, and
said network interface comprising a connection for communicating with the program for selectively modifying the protocol.

14. A meat aging apparatus according to claim 13 further comprising an alarm system comparing current aging parameter values to preselected threshold levels and providing an alarm signal to a network interface in response to a current aging parameter value crossing a threshold.

15. A meat aging apparatus according to claim 14 wherein said network interface comprises an interface to the Cloud.

16. A meat aging apparatus according to claim 13 further comprising a non-transitory programmed medium which when executed on a digital processer causes the processor to perform the step of translating environmental parameter readings into visual representations on a graphical user interface.

17. A meat aging apparatus according to claim 16 wherein said non-transitory programmed medium further causes the processor to transmit commands to the operational control circuit for varying aging parameters in accordance with inputs from a user.

18. A meat aging apparatus according to claim 17 wherein non-transitory programmed medium further causes the processor to seek access to media in response to inputs from a user.
